(19) United States
(12) Patent Application Publication
(10) Pub. No.: US 2012/0117062 A1
(43) Pub. Date: May 10, 2012

(54) INFORMATION COLLECTION SYSTEM

(76) Inventors: Harukazu Suematsu, Fukuoka (JP); Masayoshi Nakamura, Fukuoka (JP)

(21) Appl. No.: 13/261,032

(22) PCT Filed: Jul. 29, 2010
(86) PCT No.: PCT/JP2010/062773

§ 371 Date: Dec. 15, 2011

(30) Foreign Application Priority Data
Jul. 31, 2009 (JP) 2009-179384

(51) Int. Cl. G06F 17/30

(52) U.S. Cl. 707/736; 707/E17.058; 707/E17.107

(57) ABSTRACT

There is provided an information collecting system capable of collecting general information. An accusation information collecting system 1 is constituted by accusation information providing terminals 2 to be used by accusers, a management server 3 and accusation information browsing terminals 5 to be used by accusation information browsing persons. The accusation information providing terminal 2 has an accusation information transmitting unit 11 for transmitting accusation information to the management server 3 via the Internet 4. The management server 3 has: an accusation information receiving unit 6 for receiving accusation information from the accusation information providing terminal 2; an accusation information database 7 for recording received pieces of accusation information by predetermined kind; an accusation information counting unit 8 for counting recorded pieces of accusation information by predetermined kind; a predetermined number reaching accusation information transmitting unit 9 for transmitting the same kind of accusation information, of which the number of counted pieces reaches a predetermined number, to the accusation information browsing terminal 5; and an accusation service database 10 for recording accusation information, which is to be selected via the accusation information providing terminal 2, as an option template.

### TECHNICAL FIELD

The present invention relates to an information collecting system, more particularly, the present invention relates to an information collecting system for collecting a certain number of pieces of information on accusations.

### BACKGROUND ART

Conventionally, as one type of information collecting system, a system has been proposed which collects information on accusations (see, for example, Patent Document 1).

Patent Document 1 discloses a complaint information processing system including: a center server; user's communication terminals connected to the center server via the Internet; communication terminals of employees of each company; and communication terminals of persons in charge of each company, wherein the center server includes: a unit for transmitting a form for inputting complaint information into the user's communication terminal; a unit for correlating complaint information on a specified company, the information being transmitted from the user's communication terminal, with the company and registering the complaint information in a predetermined database; a unit for transmitting a form for inputting complaint information into the communication terminal of an employee of each company; a unit for correlating complaint information on a company of the employee, the information being transmitted from the employee's communication terminal, with the company and registering the complaint information in the predetermined database; and a unit for transmitting complaint information on a specified company, the information being registered in the database, to the communication terminal of a person in charge of the company.

### PRIOR ART

Patent Document 1: Japanese Published Unexamined Patent Application No. 2004-46588

### SUMMARY OF THE INVENTION

### Problem to be Solved by the Invention

However, a system disclosed in Patent Document 1 cannot determine whether a user transmits complaint information self-righteously or on behalf of a great number of users, and cannot sufficiently collect general opinions (information) of users (accusers).

The present invention has been made in view of the above problem and the object thereof is to provide an information collecting system capable of collecting general information.

### Means for Solving the Problem

The inventors of the present invention conducted a wide range of research in order to achieve the above object and obtained the following knowledge.

First, “accusation” imposes a heavy burden on an accuser.

That is, by making an accusation, a group or person that has done something illegal loses social credibility, achievement of a group/person lowers, and a group is frequently driven into bankruptcy or break up, or a person is frequently driven to resign. In addition, an accusation has a significant impact not only on a group or person that has done something illegal but also on a group or person having a relationship with the former group or person. Accordingly, an accuser is, after an accusation, frequently forced to fall into a disadvantageous situation, for example, receives unfair treatment from an accused group or person or is driven to resign. As described above, “accusation” imposes a heavy burden on an accuser.

Since contents of an accusation frequently relate to an event in which an accuser itself is deeply involved or an event occurring around the accuser itself, the accusation is extremely high in reliability and can be greatly expected to solve various problems caused by illegal acts. However, under the present circumstances, an accusation is difficult to make due to the burdens imposed on an accuser described above.

Moreover, an accuser frequently hesitates to make an accusation when imagining himself/herself falling into a disadvantageous situation. However, when many persons intend to make the same accusation as that of the accuser, the accusation can be easily made in a manner that they unite with each other to form into a group. However, there is a risk that, when a person searches for another person intending to make the same accusation as that of himself/herself, the search itself might widely inform a group and its surroundings or a person and his/her surroundings of the intention of making the accusation.

The present invention has been made based on the above knowledge, and an information collecting system of the present invention includes a management server having: an information recording unit for recording accusation information which is transmitted from an information providing terminal and contains at least two of a name of an accused group or person, an accusatory subject and an accusatory event; an information counting unit for counting pieces of accusation information, which are recorded in the information recording unit and have the same combination of at least two of a name of an accused group or person, an accusatory subject and an accusatory event, as one kind; and a predetermined number reaching information transmitting unit for transmitting the same kind of accusation information, of which the number of pieces counted by the information counting unit reaches a predetermined number, to an information browsing terminal.

Here, since the information counting unit counts pieces of accusation information, which have the same combination of at least two of a name of an accused group or person, an accusatory subject and an accusatory event, as one kind and the same kind of accusation information, of which the number of counted pieces reaches the predetermined number, is transmitted to the information browsing terminal, an extremely small number of pieces of non-general accusation information can be prevented from being transmitted to the information browsing terminal, general accusation information can be collected and an accuser can be protected.

Moreover, “predetermined number” indicates a number predetermined by a manager in charge of managing the management server, etc.

When the information counting unit counts pieces of accusation information, which have the same combination of a name of an accused group or person, an accusatory subject and an accusatory event, as one kind, an extremely small number of pieces of non-general accusation information can be further prevented from being transmitted to the information browsing terminal, general accusation information can be further collected and an accuser can be further protected.

The management server has a public information recording unit for recording information, which is to be selected via the information providing terminal, as an option template. When accusation information transmitted from the information providing terminal is information which is selected, via the information providing terminal, from options of the option template recorded in the public information recording unit and is input into a template, the accusation information is easily made to belong to a predetermined kind.

In addition, the management server has an information receiving unit for receiving accusation information transmitted from the information providing terminal. The information receiving unit can temporarily record accusation information transmitted from the information providing terminal, and delete the accusation information temporarily recorded in the information receiving unit when it is forwarded to the information recording unit. Thus, accusation information transmitted from the information providing terminal can be safely protected.

When the information recoding unit records the number of pieces of accusation information by predetermined kind, the pieces being counted by the information counting unit, the number of pieces of each kind of accusation information is easily analyzed.

When the information recording unit records information, which is transmitted from the information providing terminal, with a proper unit for prohibiting access from the outside, unintended leakage of information can be prevented and information can be provided without worry.

### EFFECT OF THE INVENTION

An information collecting system according to the present invention can collect general information.

### BRIEF DESCRIPTION OF THE DRAWINGS

FIG. 1 is a schematic diagram illustrating a constitutional example of an accusation information collecting system of the present invention.

FIG. 2 is a table indicating an example of a question template recorded in an accusation service database.

FIG. 3 is a table indicating an example of an option template recorded in the accusation service database.

FIG. 4 is a schematic diagram illustrating various examples of an access limitation range.

FIG. 5 is a flowchart indicating an example of a processing flow of the accusation information collecting system of the present invention.

### BEST MODES FOR CARRYING OUT THE INVENTION

Hereinafter, an embodiment of the present invention will be described with reference to the drawings for an understanding of the present invention.

Moreover, hereinafter, a police department, consumer affairs agency, local self-governing body, fair trade commission, regional taxation bureau, newspaper company, broadcasting station, etc., are included in a “group” receiving an accusation (a group using an accusation information browsing terminal 5 described below and receiving accusation information), and a lawyer, licensed tax accountant, etc., are included in a “person” receiving an accusation (a person using the accusation information browsing terminal 5 described below and receiving accusation information).

A company, cooperative, political organization, religious organization, nonprofit organization, etc., are included in a “group” introducing a system of the present invention, and an individual enterpriser, public employee, etc., are included in a “person” introducing the system of the present invention.

In addition, a company, cooperative, political organization, religious organization, nonprofit organization, etc., are included in a “group” not introducing the system of the present invention, and an individual enterpriser, public employee, etc., are included in a “person” not introducing the system of the present invention.

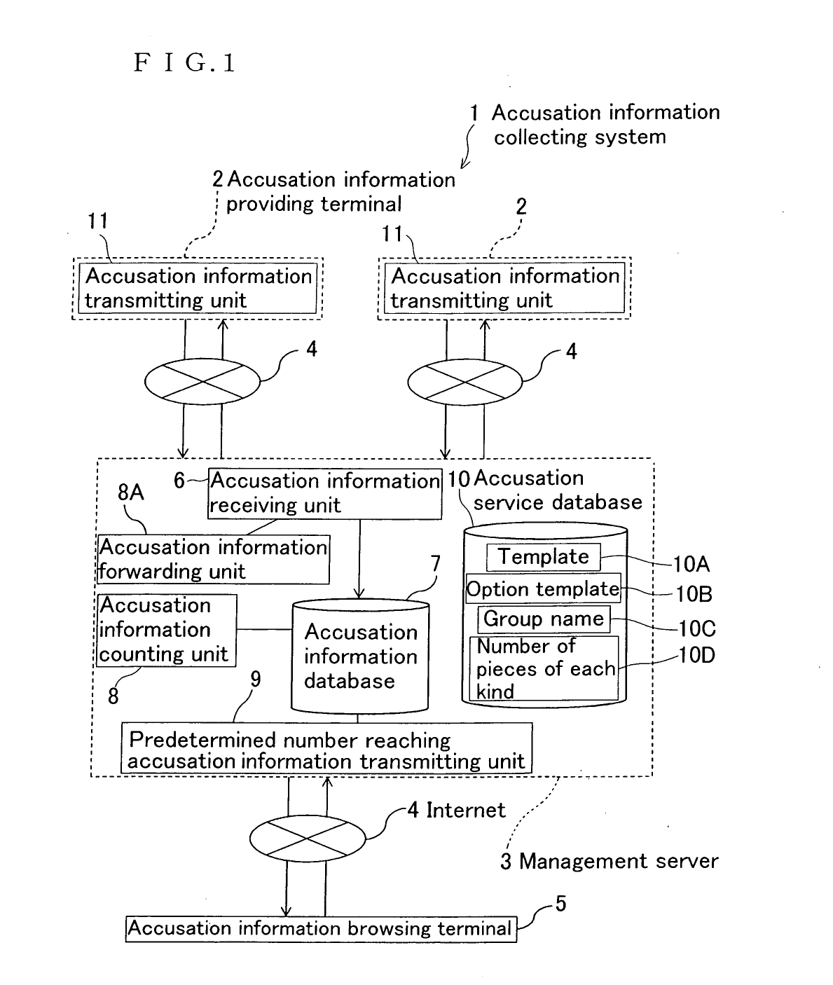

FIG. 1 is a schematic diagram illustrating a constitutional example of an accusation information collecting system of the present invention.

As illustrated in FIG. 1, an accusation information collecting system 1 of the present invention is constituted by accusation information providing terminals 2, a management server 3 and accusation information browsing terminals 5 used by accusation information browsing persons (for example, a group receiving an accusation or accused group).

The accusation information providing terminal 2 has an accusation information transmitting unit 11 for transmitting accusation information to the management server 3 via the Internet 4.

The management server 3 has: an accusation information receiving unit (an example of an information receiving unit) 6 for receiving accusation information transmitted from the accusation information providing terminal 2; and an accusation information database (an example of an information recording unit) 7 for recording accusation information received by the accusation information receiving unit 6.

In addition, the management server 3 has an accusation information counting unit (an example of an information counting unit) 8 for counting the number of pieces of accusation information recorded in the accusation information database 7 by predetermined kind and an accusation information forwarding unit 8A for forwarding accusation information from the accusation information receiving unit 6 to the accusation information database 7.

In the embodiment, pieces of accusation information having the same combination of “name of accused group+article or service of accusation+accusatory event” are recorded as one kind, and when pieces of accusation information have the same name of an accused group and the same article or service, however, different accusatory events, these are recorded as different kinds of accusation information.

Furthermore, the management server 3 has a predetermined number reaching accusation information transmitting unit (an example of a predetermined number reaching information transmitting unit) 9 for transmitting the same kind of accusation information, of which the number of pieces counted by the accusation information counting unit 8 reaches a predetermined number (pool prescribed number) of two or more, to the accusation information browsing terminal 5.

Furthermore, the management server 3 has an accusation service database (an example of a public information recording unit) 10 for recording accusation information, which is to be selected via the accusation information providing terminal 2, as an option template. Accusation information received by the accusation information receiving unit 6, that is, accusation information transmitted from the accusation information providing terminal 2, is information on responses to questions in a template recorded in the accusation service database 10.

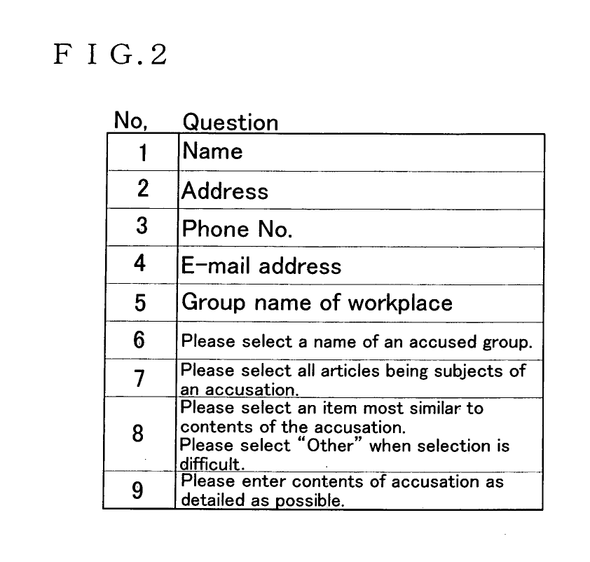

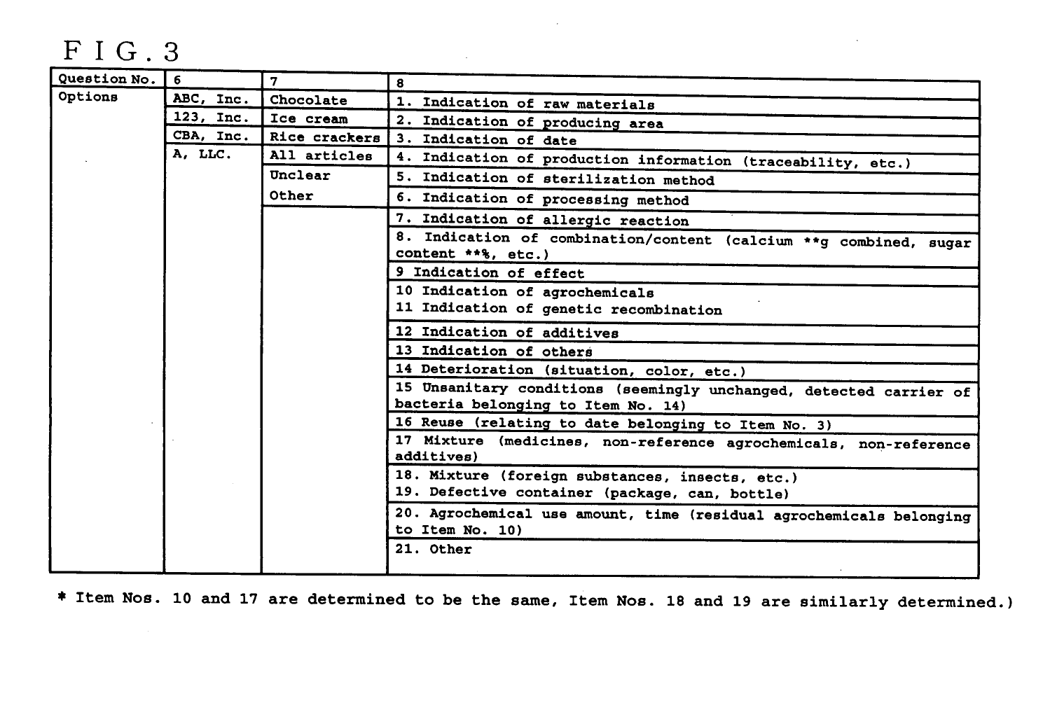

In questions in a template exemplified in FIG. 2 as a template 10A recorded in the accusation service database 10, information for identifying an accuser (name, address, phone number, e-mail address, group name of workplace, etc.), a name of an accused group, an article or service of accusation, an accusatory event, details of an accusation, etc., are included. Since a program is required to determine whether pieces of accusation information exist which have the same “name of accused group,” “article or service of accusation” and “accusatory event,” accusation information is input, in consideration of easiness of determination, in a manner of selecting one from options in an option template 10B (see FIG. 3) recorded in the accusation service database 10.

Moreover, the “accusatory event,” for example, in the case where an accusatory subject is on foods, specifically indicates accusation items, “indication of raw materials” in the case where an indication of raw materials is doubtful, “indication of producing area” in the case where an indication of a producing area is doubtful, etc.

“Name of accused group” in the option template 10B is a name of a group introducing the system of the present invention, and “article or service of accusation” therein is an article or service handled with the group introducing the system of the present invention.

A group name 10C recorded in the accusation service database 10 is a name of a group which contracts with a manager of the management server 3 and introduces the system of the present invention.

The accusation information receiving unit 6 temporarily records accusation information, and deletes the temporarily recorded accusation information in the accusation information receiving unit 6 when it is forwarded to the accusation information database 7.

The accusation information database 7 records the number of pieces of accusation information counted by the accusation information counting unit 8 by predetermined kind.

The management server 3 is not always required to have the accusation information receiving unit 6.

When the management server 3 does not have the accusation information receiving unit 6, the accusation information database 7 may record pieces of accusation information without sorting the information, or the number of pieces of accusation information may be counted and recorded by the accusation information counting unit 8 by predetermined kind.

Also when the management server 3 has the accusation information receiving unit 6, the accusation information database 7 may record pieces of accusation information without sorting the information, or the number of pieces of record accusation information may be counted and recorded by the accusation information counting unit 8 by predetermined kind.

Although pieces of accusation information having the same combination of “name of accused group+article or service of accusation+accusatory event” are counted as one kind in the embodiment, pieces of accusation information having the same combination of at least two of a name of an accused group or person, an accusatory subject and an accusatory event may be counted as one kind as long as a burden to an accuser caused due to transmission of an extremely small number of pieces of accusation information to the information browsing terminal can be suppressed.

That is, pieces of accusation information having the same combination of “name of accused group (or person)+article or service of accusation” may be counted as one kind, pieces of accusation information having the same combination of “name of accused group (or person)+accusatory event” may be counted as one kind, or pieces of accusation information having the same combination of “article or service of accusation+accusatory event” may be counted as one kind.

In the case where pieces of accusation information having the same combination of “name of accused group (or person)+article or service of accusation” are counted as one kind, for example, since ranges of accusatory events that accusers know are different or each accuser has its own expressing method of the accusatory event, there is a risk that pieces of accusation information seeming to have different accusatory events are transmitted although really having the same accusatory event. However, even in this case, the pieces of accusation information can be properly sorted.

Specifically, regarding an accusatory event that an article is repacked and the expiration date thereof is falsified, two cases are considered where “repacking” is selected by an accuser and “falsification of expiration date” is selected. However, by sorting pieces of accusation information as the same kind regardless of identity of accusatory events, proper sorting is realized.

Regarding the case where pieces of accusation information having the combination of “name of accused group (or person)+accusatory event” are counted as one kind, proper sorting can be realized, for example, when a common accusatory event exists on a plurality of articles.

Specifically, when “mixing of foreign substances” is recognized on a material commonly used in “Article A,” “Article B” and “Article C,” proper sorting is realized by sorting pieces of accusation information as the same kind regardless of the kind of a target article.

Regarding the case where pieces of accusation information having the same combination of “article or service of accusation+accusatory event” are counted as one kind, for example, in the case where a common problem is caused to a plurality of accused groups (persons), proper sorting is realized by sorting pieces of accusation information as the same kind regardless of identity of names of the accused groups (persons).

Specifically, when “danger of injury” exists on an article manufactured by a manufacturer, A company, and sold by a seller, B company, proper sorting is realized by sorting pieces of accusation information as the same kind regardless of a name of an accused group (person).

However, as indicated in the description of the embodiment, pieces of accusation information having the same combination of “name of accused group+article or service of accusation+accusatory event” are preferably counted as one kind in consideration of suppressing a burden to an accuser, the burden being caused by transmission of an extremely small number of pieces of accusation information to the information browsing terminal.

Although the embodiment is described by citing the case where accusation information is transmitted in a manner of responding to the questions of the template recorded in the accusation service database 10, accusation information is not always required to be transmitted in a manner of responding to questions of a template and may be transmitted by any method.

For example, in the case where accusation information indicates “embezzlement” of “B employee” of “A company,” accusation information may be transmitted, without indicating that an accused group is “A company,” by accessing a homepage of “A company” and inputting only information, which indicates “embezzlement” is performed by “B employee”, into the template. In this case, since an accuser inputs a response into the template prepared on the homepage of A company, the accusation information is transmitted without requesting the accuser to indicate that an accused group is “A company.”

There is a case where items in the template selected by accusers are different even if the contents of accusations are the same. Therefore, even if selected items in the template are different, pieces of accusation information having contents corresponding to the selected items may be sorted as the same kind. For example, “10 Indication of agrochemicals” and “17 Mixture (medicines, non-reference agrochemicals, non-reference additives)” in FIG. 3 may be determined to be the same, or “18 Mixture (foreign substances, insects, etc.)” and “19 Defective container (package, can, bottle)” in FIG. 3 may be determined to be the same.

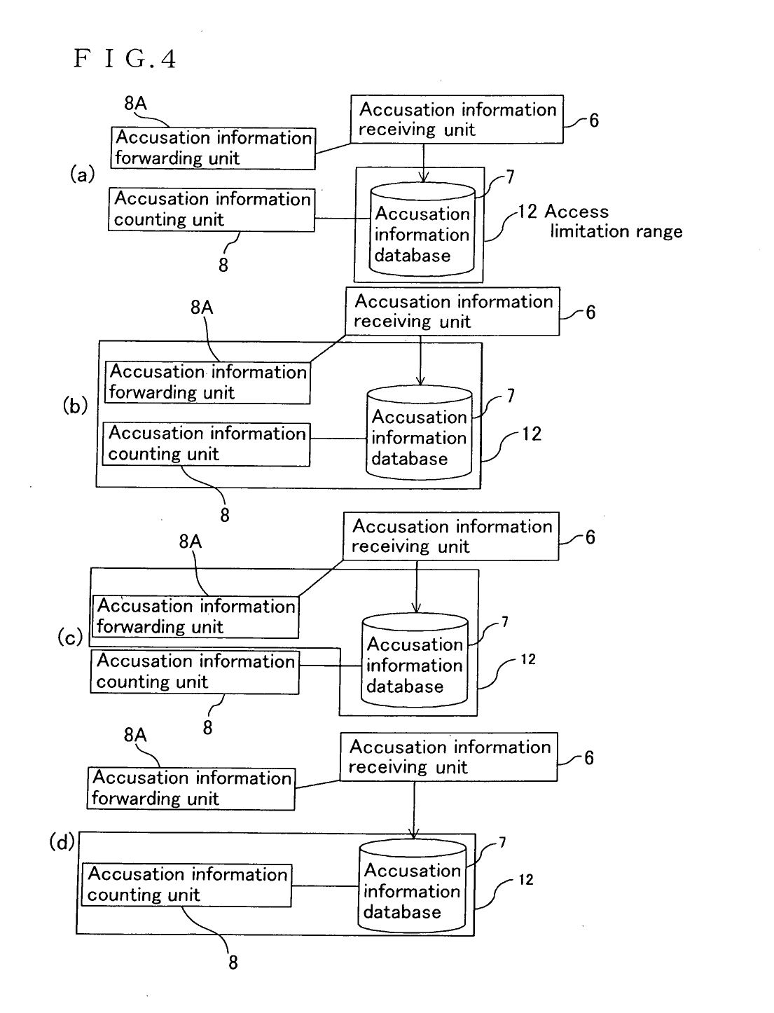

FIG. 4 is a schematic diagram illustrating various examples of an access limitation range. FIG. 4(a) illustrates an example that access limitation is set only to the accusation information database 7 and not set to the accusation information counting unit and the accusation information forwarding unit 8A (illustrated as an access limitation range 12). In this case, only the accusation information counting unit 8 and the accusation information forwarding unit 8A can access the accusation information database 7.

FIG. 4(b) illustrates another example that access limitation is set to the accusation information database 7, the accusation information counting unit 8 and the accusation information forwarding unit 8A. In this case, access cannot be made not only to the accusation information database 7 but also to the accusation information counting unit 8 and the accusation information forwarding unit 8A.

FIG. 4(c) illustrates another example that access limitation is set to the accusation information database 7 and the accusation information forwarding unit 8A and not set to the accusation information counting unit 8.

FIG. 4(d) illustrates another example that access limitation is set to the accusation information database 7 and the accusation information counting unit 8 and not set to the accusation information forwarding unit 8A.

Moreover, in the cases illustrated in FIGS. 4(b), 4(c) and 4(d), the accusation information counting unit 8 and the accusation information forwarding unit 8A can access the accusation information database 7.

Thus, illegal acts can be prevented that, for example, authorization of access to the accusation information database 7 possessed by the accusation information counting unit 8 and the accusation information forwarding unit 8A is analyzed and accusation information is stolen therefrom.

The same kind of accusation information, of which the number of pieces does not reach the predetermined number (pool prescribed number), is recorded in a format that none of the persons including the manager can determine the contents of the information. When the number of pieces of accusation information reaches the predetermined number (pool prescribed number), the format of the accusation information is returned to the original format that the contents of the information is determined.

Moreover, different from the accusation information database 7, the accusation service database 10 can receive access from various terminals to widely disclose information.

Some of a predetermined number of pieces of the same kind of accusation information recorded in the accusation information database can be transmitted to the accusation information browsing terminal 5 or can be recorded, as a number 10D of the kind, in the accusation service database 10 and the information can be widely disclosed.

Since both the accusation information providing terminal 2 and the accusation information browsing terminal 5 can be connected to the Internet, the accusation information providing terminal/accusation information browsing terminal frequently serve as the accusation information browsing terminal/accusation information providing terminal.

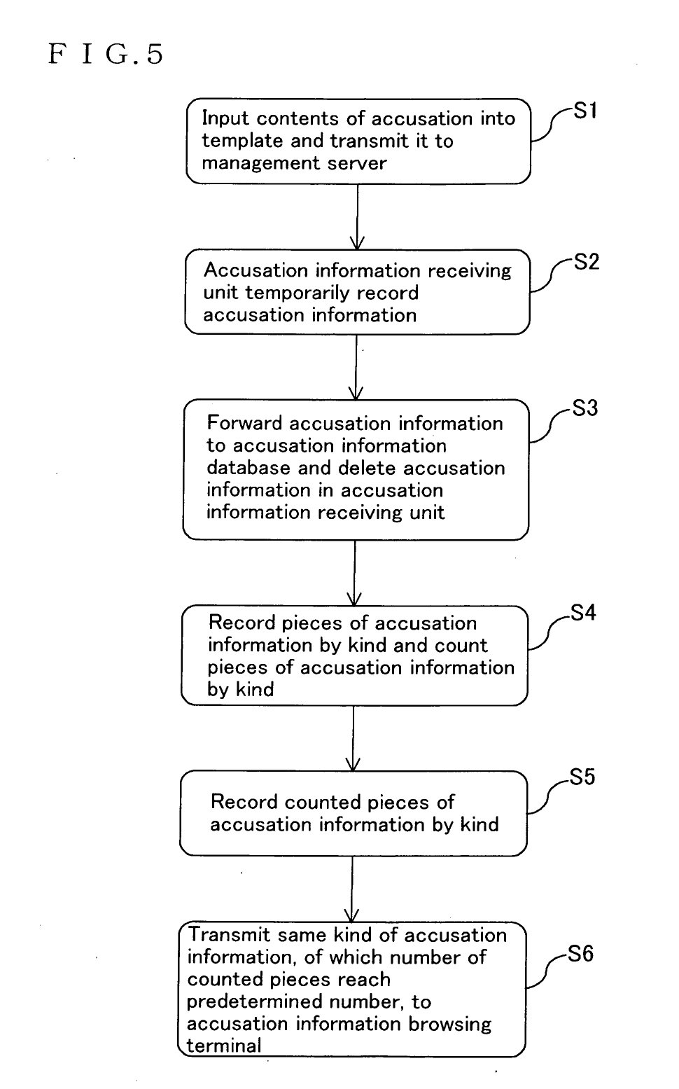

FIG. 5 is a flowchart indicating an example of a processing flow of the accusation information collecting system of the present invention.

An accuser intending to carry out an accusation accesses the accusation service database 10 of the management server 3 from the accusation information providing terminal 2, inputs the contents of the accusation into the template recorded in the accusation service database 10 and transmits the contents as accusation information from the accusation information providing terminal 2 to the management server 3 (Step S1).

Next, the accusation information receiving unit 6 of the management server 3 receives and temporarily records the accusation information transmitted from the accusation information providing terminal 2 (Step S2).

The accusation information is then forwarded from the accusation information receiving unit 6 to the accusation information database 7 and deleted from the accusation information receiving unit 6 (Step S3).

The accusation information database 7 here records pieces of accusation information by predetermined kind, and the accusation information counting unit 8 counts pieces of accusation information, which are recorded in the accusation information database 7, by predetermined kind (Step S4).

In addition, the accusation information database 7 records the number of counted pieces of accusation information by predetermined kind (Step S5).

The same kind of accusation information, of which the number of counted pieces reaches the predetermined number (pool prescribed number), is transmitted to the accusation information browsing terminal 5 via the Internet 4 (Step S6).

As long as accusation information can be transmitted to the accusation information browsing terminal 5, the same kind of accusation information, of which the number of counted pieces reaches the predetermined number (pool prescribed number), may be, of course, directly transmitted to the accusation information browsing terminal 5, or may be transmitted to another server and temporarily recorded in a predetermined database so as to be transmitted to the accusation information browsing terminal 5 from the server.

Through each of the steps, an accusation information browsing person can browse accusation information.

Although an article or service is here cited as an example of an accusatory subject, it is possible to respond to accusations on various illegal acts by changing the contents of the template. Here, in “various illegal acts,” fraudulent accounting, kickbacks, collusion, embezzlement, bribery, etc., can be cited. In addition, although the case is here described where a group is accused, a person can also be accused.

As described above, the system of the present invention transmits the same kind of accusation information, of which the number of counted pieces reaches the predetermined number (pool prescribed number), to the accusation information browsing terminal, and thus can remove an extremely small number of pieces of non-general accusation information and collect general accusation information.

Since the same kind of accusation information, of which the number of counted pieces does not reach the predetermined number (pool prescribed number), is recorded in the accusation information database with the information attributed to none of the persons including the manager, the risk that an accuser falls into a disadvantageous situation is reduced and an accusation is easily carried out.

In addition, since accusation information is not disclosed until the number of pieces of the information reaches the predetermined number (pool prescribed number), a small number of pieces of accusation information are not disclosed. Accordingly, an accuser can provide accusation information without a feeling of uneasiness.

By introducing the system of the present invention, no one can attribute the intention of making an accusation until a predetermined number (pool prescribed number) of pieces of accusation information having the same content are collected. Since, when a predetermined number (pool prescribed number) of pieces of accusation information having the same content are collected, many persons having the same intention of making an accusation exist and the accusation can be carried out by a group.

A group or person introducing the system of the present invention makes accusation information on an illegal act more easily disclosable.

Accordingly, the group or person introducing the system of the present invention is more severely required to execute compliance against illegal acts. This is reflected in the prevention of illegal acts on an article or service or other illegal acts.

A group or person introducing the system of the present invention advertises the introduction of the system with use of an advertisement medium, discloses the introduction of the system on an article package or widely announces the introduction at shops or on streets, and thus there is obtained an effect that safety and a feeling of easiness in the group, person, article or service is indicated to an object (consumers, voters, customers, unionists, etc.), from which the group or person intends to obtain reliability, and evaluation to the group, person, article or service is enhanced.

For example, if a company advertises “our company introduces the information collecting system of the present invention,” there is obtained an effect that the consumers' evaluation of the company and articles thereof is enhanced.

Regarding, for example, an article which indicates a producing area name, “xxx chicken of xxx area,” and is provided with an area-brand by a plurality of producers, if an information collecting system is introduced which enables not only the producers and their related parties but residents of the area to provide information, there is obtained an effect that higher evaluation is imparted to a feeling of easiness in and safety of the article having such an indication by consumers compared with those of an article having a conventional indication.

A group or person introducing the system of the present invention can realize differentiation of himself/his article or service from a group or person not introducing the system/its article or service.

The system, by checking a name or e-mail address of an accuser, etc., enables the accuser not to provide accusation information having the same contents.

### DESCRIPTION OF SYMBOLS

1: Accusation information collecting system
2: Accusation information providing terminal
3: Management server
4: Internet
5: Accusation information browsing terminal
6: Accusation information receiving unit
7: Accusation information database
8: Accusation information counting unit
8A: Accusation information forwarding unit
9: Predetermined number reaching accusation information transmitting unit
10: Accusation service database
10A: Template
10B: Option template
10C: Group name
10D: Number of pieces of each kind
11: Accusation information transmitting unit
12: Access limitation range

What is claimed is:

1. An information collecting system comprising a management server, the management server having:
an information recording unit for recording accusation information which is transmitted from an information providing terminal and contains at least two of a name of an accused group or person, an accusatory subject and an accusatory event;
an information counting unit for counting pieces of accusation information, which are recorded in the information recording unit and have the same combination of at least two of a name of an accused group or person, an accusatory subject and an accusatory event, as one kind; and
a predetermined number reaching information transmitting unit for transmitting accusation information, of which the number of pieces counted by the information counting unit reaches a predetermined number, to an information browsing terminal.

2. The information collecting system according to claim 1,
wherein the information recording unit records accusation information which is transmitted from the information providing terminal and contains a name of an accused group or person, an accusatory subject and an accusatory event, and
the information counting unit counts pieces of accusation information, which are recorded in the information recording unit and have the same combination of a name of an accused group or person, an accusatory subject and an accusatory event, as one kind.

3. The information collecting system according to claim 1 or 2,
wherein the management server has a public information recording unit for recording information, which is to be selected via the information providing terminal, as an option template, and
accusation information transmitted from the information providing terminal is information which is selected, via the information providing terminal, from options in the option template recorded in the public information recording unit and is input into a template.

4. The information collecting system according to claim 1 or 2,
wherein the management server has an information receiving unit for receiving accusation information transmitted from the information providing terminal, and
the information receiving unit temporarily records accusation information transmitted from the information providing terminal, and deletes the temporarily recorded information when the accusation information is forwarded to the information recording unit.

5. The information collecting system according to claim 1 or 2, wherein the information recording unit records the number of pieces of accusation information, the pieces being counted by the information counting unit, by predetermined kind.
